(19) United States
(12) Patent Application Publication
(10) Pub. No.: US 2026/0338409 A1
(43) Pub. Date: Oct. 29, 2026

(54) AIR OUTLET DEVICE AND AIR CONDITIONING APPARATUS

(71) Applicant: GD Midea Environment Appliances MFG Co., Ltd., Zhongshan (CN)

(72) Inventors: Guopeng He, Zhongshan (CN); Shiqiang Cui, Zhongshan (CN); Du Wang, Zhongshan (CN); Runming Guo, Zhongshan (CN); Weiliang Liu, Zhongshan (CN); Tonngjing Tan, Zhongshan (CN); Xuefeng Xu, Zhongshan (CN); Huacheng Hu, Zhongshan (CN); Xie Chen, Zhongshan (CN); Rihua Yu, Zhongshan (CN); Jiabin Wen, Zhongshan (CN); Zijian Li, Zhongshan (CN); Deming Yao, Zhongshan (CN); Junfeng Zeng, Zhongshan (CN); Zhibei Liu, Zhongshan (CN)

(21) Appl. No.: 19/655,706

(22) Filed: Apr. 23, 2026

(30) Foreign Application Priority Data
Apr. 23, 2025 (CN) 202510519558.9

(51) Int. Cl. F24F 13/15

(52) U.S. Cl. CPC F24F 13/15

(57) ABSTRACT

An air outlet device and an air conditioning apparatus are provided. The air outlet device includes an air outlet frame, a fan blade assembly and a drive assembly. The fan blade assembly includes at least a first fan blade and a second fan blade, one end of the first fan blade is meshed with one end of the second fan blade. Both the first fan blade and the second fan blade are rotatably provided on the air outlet frame. The drive assembly is drivingly connected to the first fan blade to drive the first fan blade to rotate in a first direction, causing the first fan blade to drive the second fan blade to rotate in a second direction opposite to the first direction. The air outlet device in the present disclosure can achieve synchronous air supply in opposite directions, thereby increasing the air supply coverage area.

### CROSS-REFERENCE TO RELATED APPLICATION

This application claims priority to Chinese Patent Application No. 202510519558.9, titled “AIR OUTLET DEVICE AND AIR CONDITIONING APPARATUS” and filed with the China National Intellectual Property Administration on Apr. 23, 2025, the entire contents of which are incorporated herein by reference.

### TECHNICAL FIELD

The present disclosure relates to the technical field of air conditioning apparatuses, and in particular to an air outlet device and an air conditioning apparatus.

### BACKGROUND

In modern life, people widely use air conditioning apparatuses, such as air conditioners, electric fans, fan heaters and humidifiers, to adjust air parameters such as air speed, temperature and humidity.

In the related art, the air conditioning apparatus drives fan blades using a synchronous motor or a stepper motor, to drive the fan blades to oscillate for air supply, thereby achieving the function of air supply through oscillation. However, during the air supply through oscillation, the fan blades always first swing to one side (such as a left side), and after reaching a position, swing to the other side (such as a right side). At a given moment, the fan blades can only swing in one direction and can only supply air to one side, failing to supply air to the other side, thereby resulting in a small air supply coverage area.

### SUMMARY

Embodiments of the present disclosure provide an air outlet device and an air conditioning apparatus, which can increase the air supply coverage area.

In a first aspect, embodiments of the present disclosure disclose an air outlet device, including an air outlet frame, a fan blade assembly and a drive assembly. The fan blade assembly includes at least a first fan blade and a second fan blade, wherein one end of the first fan blade is meshed with one end of the second fan blade, and both the first fan blade and the second fan blade are rotatably provided on the air outlet frame. The drive assembly is drivingly connected to the first fan blade to drive the first fan blade to rotate in a first direction, causing the first fan blade to drive the second fan blade to rotate in a second direction opposite to the first direction.

In some embodiments, the first fan blade includes a first blade and a first meshing portion provided at one end of the first blade; and
the second fan blade includes a second blade and a second meshing portion provided at one end of the second blade, wherein the second meshing portion is meshed with the first meshing portion.

In some embodiments, the first meshing portion includes at least two first meshing teeth, which are spaced apart to form at least one first tooth space; and
the second meshing portion includes at least one second meshing tooth extending into the first tooth space.

In some embodiments, the first meshing portion further includes two first limiting portions, and the at least two first meshing teeth are located between the two first limiting portions in a circumferential rotation direction of the first fan blade; and
the second meshing portion further includes two second limiting portions, and the at least one second meshing tooth is located between the two second limiting portions in a circumferential rotation direction of the second fan blade, wherein both the second limiting portions are spaced apart from the at least one second meshing tooth to form second tooth spaces, and the two first meshing teeth extend into the two second tooth spaces respectively; and
wherein the two first limiting portions are configured to abut against the second limiting portions in a one-to-one correspondence to limit a relative rotation angle of the first fan blade with respect to the second fan blade.

In some embodiments, the first meshing portion and the first blade are an integral member, and the second meshing portion and the second blade are an integral member.

In some embodiments, the air outlet device further includes:
a mounting bracket connected to the air outlet frame, wherein the mounting bracket is provided with a mounting groove, in which both the first meshing portion and the second meshing portion are rotatably disposed.

In some embodiments, the mounting bracket includes:
a third limiting portion provided on a wall of the mounting groove; and
wherein the third limiting portion is configured to abut against any one of the second limiting portions to limit a relative rotation angle of the second fan blade with respect to the mounting bracket.

In some embodiments, the mounting groove includes:
a first sub-groove, wherein the first meshing portion is rotatably limited in the first sub-groove; and
a second sub-groove communicating with the first sub-groove, wherein the second meshing portion is rotatably limited in the second sub-groove.

In some embodiments, the first fan blade and the second fan blade are arranged in a vertical direction, and the first meshing portion and the second meshing portion are meshed with each other in a left-right direction or a front-rear direction of the air outlet frame.

In some embodiments, a dimension of mutual meshing between the first meshing portion and the second meshing portion in the first direction is no less than 4 mm.

In some embodiments, the first fan blade and the second fan blade are arranged in a vertical direction, or the first fan blade and the second fan blade are arranged in a left-right direction.

In some embodiments, the first fan blade is arranged coaxially with the second fan blade, or rotation axes of the first fan blade and the second fan blade are parallel to each other.

In some embodiments, wherein there are a plurality of first blades and a plurality of second blades, and the air outlet device further includes:
a connecting member, connecting all the first blades so that all the first blades rotate synchronously, and/or, connecting all the second blades so that all the second blades rotate synchronously; and
wherein at least one of the first blades is meshed with at least one of the second blades, or the plurality of first blades and the plurality of second blades are meshed with each other in a one-to-one correspondence.

In some embodiments, the fan blade assembly further includes:
a third fan blade, wherein the third fan blade is meshed with the first fan blade, such that the first fan blade drives the third fan blade to rotate in the second direction; or, the third fan blade is meshed with the second fan blade, such that the second fan blade drives the third fan blade to rotate in the first direction.

In some embodiments, one of the air outlet frame and an end of the first fan blade away from the second fan blade is provided with a first snap-fit member and the other is provided with a first slot, the first snap-fit member is in snap-fit engagement with the first slot and is rotatably disposed in the first slot; and/or
one of the air outlet frame and an end of the second fan blade away from the first fan blade is provided with a second snap-fit member and the other is provided with a second slot, the second snap-fit member is in snap-fit engagement with the second slot and is rotatably disposed in the second slot.

In some embodiments, the drive assembly includes:
a drive member;
a drive wheel, wherein the drive wheel is eccentrically connected to an output shaft of the drive member or is an eccentric wheel; and
a transmission bracket having a middle portion rotatably connected to the air outlet frame, wherein the transmission bracket has one end drivingly connected to the drive wheel, and another end fixedly connected to the first fan blade or the second fan blade.

In some embodiments, the drive assembly is provided above the fan blade assembly, one of the transmission bracket and the first fan blade is provided with a third snap-fit member, the other of the transmission bracket and the first fan blade is provided with a third slot, wherein the third snap-fit member is in snap-fit engagement with and fixedly connected to the third slot.

In a second aspect, embodiments of the present disclosure disclose an air conditioning apparatus, including:
a main body including a fan; and
the air outlet device as described above, wherein the air outlet device is arranged on an air outlet side of the fan;
wherein the air conditioning apparatus includes one of an electric fan, an indoor air conditioning unit, an air purifier, and an air humidifier.

In the air outlet device provided in the embodiments of the present disclosure, the fan blade assembly at least includes the first fan blade and the second fan blade, wherein one end of the first fan blade is meshed with one end of the second fan blade, and both the first fan blade and the second fan blade are rotatably provided on the air outlet frame. The drive assembly is drivingly connected to the first fan blade to drive the first fan blade to rotate in the first direction, causing the first fan blade to drive the second fan blade to rotate in the second direction opposite to the first direction. In the same oscillation cycle, the first fan blade and the second fan blade rotate synchronously in opposite directions to achieve reverse oscillations. The air outlet device can simultaneously supply air to two sides that are farther apart (which can also be understood as two areas that are farther apart), thereby significantly expanding the coverage range of air supply, and increasing the air supply coverage area. It can supply air to a wider area more effectively, and can balance and optimize air output to a certain extent, making the air supply more stable and stronger, and meeting various usage needs of users.

Furthermore, the fan blade assembly is configured as a first fan blade and a second fan blade that are meshed with each other, and the first fan blade and the second fan blade can oscillate synchronously in opposite directions. Each position within a coverage range of air supply can be blown by the air twice in each oscillation cycle, thus effectively shortening the time interval for air supply and greatly improving the air supply efficiency of the air outlet device. Furthermore, as the first fan blade and the second fan blade are formed separately, this effectively resolves the problem that a single fan blade with excessive length is prone to deformation. As the first fan blade and the second fan blade rotate in opposite directions, the vibrations and noise generated during their operation can partially cancel each other out, thereby reducing the overall noise level of the air outlet device and providing users with a more comfortable and quiet user experience.

### BRIEF DESCRIPTION OF THE DRAWINGS

To describe the technical solutions in the embodiments of the present disclosure or in the prior art more clearly, the drawings required for describing the embodiments or the prior art will be briefly introduced below. Apparently, the drawings described below are merely some embodiments of the present disclosure. Other drawings can be obtained by those of ordinary skills in the art based on the structures shown in these drawings without creative efforts.

FIG. 1 is a schematic structural diagram of a first structural form of an air outlet device of the present disclosure in an assembled state;

FIG. 2 is an exploded schematic structural diagram of the first structural form of the air outlet device shown in FIG. 1;

FIG. 3 is a cross-sectional schematic structural diagram along line A-A shown in FIG. 1;

FIG. 4 is an enlarged view of point B shown in FIG. 3;

FIG. 5 is a schematic structural diagram of a first fan blade in the first structural form shown in FIG. 2;

FIG. 6 is a schematic structural diagram of a second fan blade in the first structural form shown in FIG. 2;

FIG. 7 is a schematic structural diagram of a second structural form of the air outlet device of the present disclosure in an assembled state;

FIG. 8 is a cross-sectional schematic structural diagram along line C-C shown in FIG. 7;

FIG. 9 is an enlarged view of point D shown in FIG. 8;

FIG. 10 is a schematic structural diagram of a first fan blade in the second structural form shown in FIG. 7; and

FIG. 11 is a schematic structural diagram of a second fan blade in the second structural form shown in FIG. 7.

### REFERENCE NUMERALS IN THE DRAWINGS

air outlet device 100; air outlet frame 10; top plate 10a; side plate 10b; bottom plate 10c; first slot 11; second slot 12; fan blade assembly 20; first fan blade 21; first blade 211; first meshing portion 212; first meshing tooth 2121; first tooth space 2122; first limiting portion 2123; first snap-fit member 213; third snap-fit member 214; second fan blade 22; second blade 221; second meshing portion 222; second meshing tooth 2221; second limiting portion 2222; second tooth space 2223; second snap-fit member 223; drive assembly 30; drive member 31; drive wheel 32; transmission bracket 33; third slot 331; mounting bracket 40; mounting groove 41; first sub-groove 411; second sub-groove 412; third limiting portion 42; connecting member 50; lower mounting cover 60; first direction D1; and second direction D2.

The implementation, functional features and advantages of the present disclosure will be further described with reference to embodiments and the drawings.

### DETAILED DESCRIPTION

To make the objectives, technical solutions, and advantages of the present disclosure clearer, the embodiments of the present disclosure will be further described below in detail with reference to the drawings.

In the following description, the same reference numbers in different drawings represent the same or similar elements unless otherwise indicated. The implementations described in the following exemplary embodiments do not represent all the implementations consistent with the present disclosure. Instead, they are only examples of devices and methods consistent with some aspects of the present disclosure, as detailed in the appended claims.

In the description of the present disclosure, it should be understood that the terms “first”, “second”, etc. are used for descriptive purposes only and cannot be understood as indicating or implying relative importance. For a person skilled in the art, the specific meanings of the above terms in the present disclosure can be understood based on specific situations. In addition, in the description of the present disclosure, unless otherwise stated, “a plurality of” means two or more. The “and/or” used for describing an association relationship between associated objects represents the presence of three relationships. For example, “A and/or B” may represent the presence of A only, the presence of both A and B, and the presence of B only. The character “/” generally indicates an “or” relationship between the elements it connects.

Unless otherwise defined, all technical and scientific terms used in the present disclosure have the same meaning as commonly understood by those of ordinary skills in the technical field to which the present disclosure belongs. The terms used in the specification herein are for the purpose of describing specific embodiments only and are not intended to limit the present disclosure. The term “and/or” as used herein includes any and all combinations of one or more of related associated items.

In modern life, people widely use air conditioning apparatuses, whose core function is to improve the comfort of indoor environment by controlling air parameters such as temperature, humidity, airflow speed, and air quality. These air conditioning apparatuses include but are not limited to air conditioners, electric fans, fan heaters and humidifiers.

Wherein the air conditioner uses a medium such as refrigerant as a heat carrier to exchange heat with air, thereby raising or lowering the air temperature, and blows the heated or cooled air into the room. The electric fan is based on Bernoulli's principle (that is, the air pressure is low in areas with fast flow velocity, and the air pressure is high in areas with slow flow velocity), creating a pressure difference on the upper and lower surfaces of fan blades, causing air to flow from the higher-pressure areas to the lower-pressure areas, forming an airflow and achieving the purpose of supplying air to the outside. The fan heater increases the indoor temperature by heating the drawn-in air through an electric heating element and then delivering it out. The humidifier, based on principles such as evaporation, ultrasonic vibration, and centrifugal force, uses different technical means to convert water into water mist or water vapor, thereby increasing the humidity in the air, and blows the humidified air into the room.

Regardless of the type of the air conditioning apparatuses, to achieve the air supply function, especially the function of air supply through oscillation, it is generally necessary to drive the fan blades using a synchronous motor or a stepper motor, to drive the fan blades to oscillate for air supply, that is, to achieve air supply through oscillation. However, during the air supply through oscillation, the fan blades always first swing to one side, such as a left side (or an upper side), and after reaching a position, swing to the other side, such as a right side (or a lower side). At a given moment, the fan blades can only swing in one direction and can only supply air to one side, failing to supply air to the other side, thereby resulting in a small air supply coverage area.

Taking a fan as an example, the fan blades complete one oscillation cycle after completing one left-right oscillation. Taking the rotational speed of a synchronous motor being a conventional 3 RPM as an example, it takes about 20 seconds for the synchronous motor to drive the fan blades to complete one oscillation cycle. In hot summer, people have to wait about 20 seconds at a certain position to be blown by the airflow once, which obviously affects the air blowing effect.

In addition, because the single-section fan blade is long, it tends to generate relatively loud noise during operation. The above problems indicate that the air conditioning apparatus using the single-section fan blade structure in the related art has a small air outlet coverage area and a poor air blowing effect.

To solve the above problems, the present disclosure provides an air conditioning apparatus, wherein the air conditioning apparatus includes a main body and an air outlet device. The main body includes a fan which is configured to drive the air to flow through mechanical energy. The fan includes but is not limited to a centrifugal fan, an axial fan, and a mixed-flow fan, etc. The air outlet device is arranged on an air outlet side of the fan and can deliver the airflow generated by the fan to the outside. Wherein the air conditioning apparatus includes one of an electric fan, an indoor air conditioning unit, an air purifier, and an air humidifier.

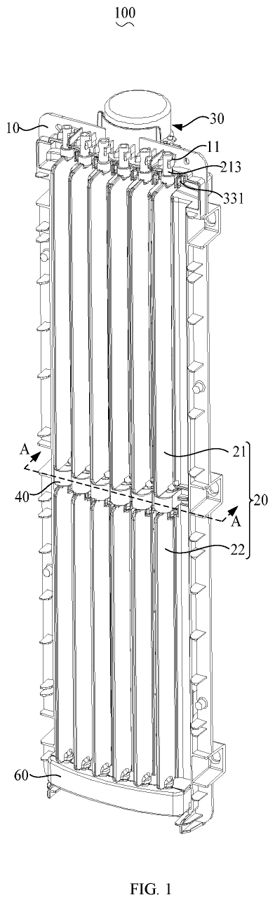

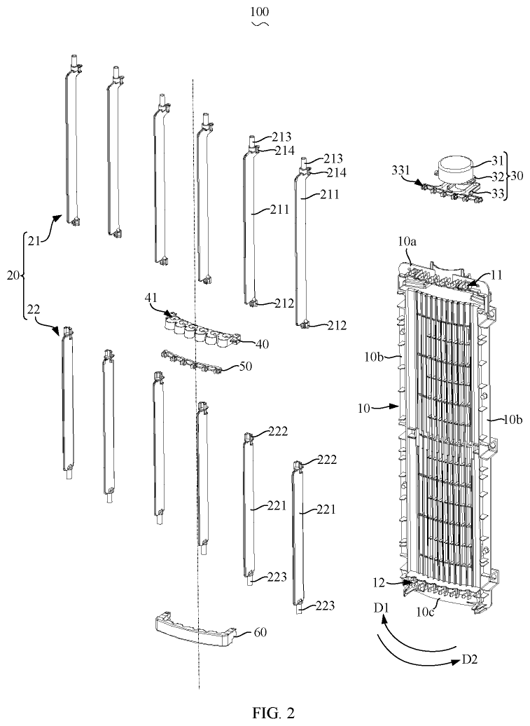

Referring to FIG. 1 to 2, in some embodiments, the air outlet device 100 includes an air outlet frame 10, a fan blade assembly 20 and a drive assembly 30.

As shown in FIG. 2, the air outlet frame 10 may be an enclosed frame structure formed by a top plate 10a, a bottom plate 10c and two side plates 10b, which is configured to support the fan blade assembly 20 and the drive assembly 30. The width of the air outlet frame 10 may be slightly larger than the oscillation travel of the fan blade assembly 20, to prevent the fan blade assembly 20 from interfering with the air outlet frame 10 during the oscillation, thereby avoiding affecting the air supply efficiency. The air outlet frame 10 may be made of materials such as aluminium, stainless steel or plastic, and the air outlet frame 10 may have a square, elliptical or any other irregular shape to adapt to different usage scenarios, which is not limited in the present disclosure.

As shown in FIG. 2, the fan blade assembly 20 includes at least a first fan blade 21 and a second fan blade 22, wherein one end of the first fan blade 21 is meshed with one end of the second fan blade 22. Both the first fan blade 21 and the second fan blade 22 are rotatably provided on the air outlet frame 10. The drive assembly 30 is drivingly connected to the first fan blade 21 to drive the first fan blade 21 to rotate in a first direction D1. Since the first fan blade 21 and the second fan blade 22 are meshed with each other, the first fan blade 21 can drive the second fan blade 22 to rotate in a second direction D2 opposite to the first direction D1. For example, if the first direction D1 is clockwise, the second direction D2 is counterclockwise. Conversely, if the first direction D1 is counterclockwise, the second direction D2 is clockwise.

Within the same oscillation cycle, the first fan blade 21 and the second fan blade 22 synchronously rotate in opposite directions, thereby achieving reverse oscillations. In this way, the air outlet device 100 can simultaneously supply air to two sides that are farther apart (which can also be understood as two areas that are farther apart), thereby significantly expanding the air supply coverage. It can deliver the air more effectively to cover a wider area, and is particularly suitable for use in larger spaces and in scenarios involving multiple people, which can meet various usage need of users.

Compared with related art, under the condition of a constant oscillation cycle (e.g., an oscillation cycle of 20 seconds), the user only needs to wait for half an oscillation cycle (e.g. 10 seconds) to be blown again, thereby reducing the user's waiting time, improving the air blowing effect, and enhancing the air supply efficiency of the air outlet device 100.

It can be understood that, within the same oscillation cycle, because the first fan blade 21 and the second fan blade 22 rotate synchronously in opposite directions, it takes only half an oscillation cycle for the airflow to reach one of the two sides which are farther apart (or one of the two areas that are farther apart) of the air outlet device 100. At this time, the other side of the two sides that are farther apart (or to the other of the two areas that are farther apart) of the air outlet device 100 can also be blown by air. After another half cycle, the same side (or the same area) of the air outlet device 100 can be blown by air again. As a result, the time interval for air supply is shortened and the air supply angle is widened, thereby increasing the air supply coverage area and improving the air supply efficiency of the air outlet device 100.

Furthermore, the first fan blade 21 and the second fan blade 22 are separately formed, which effectively solves the problem that a single fan blade with excessive length is prone to deformation. As the first fan blade 21 and the second fan blade 22 rotate in opposite directions, the vibrations and noise generated during their operation can partially cancel each other out, thereby reducing the overall noise level of the air outlet device 100. This offers significant advantages for places where a quiet environment is required, such as offices and bedrooms, thereby providing a more comfortable and quiet user experience. Furthermore, since the first fan blade 21 and the second fan blade 22 disperse the air supply, the blown air can be more uniform and gentler, resulting in a better user experience.

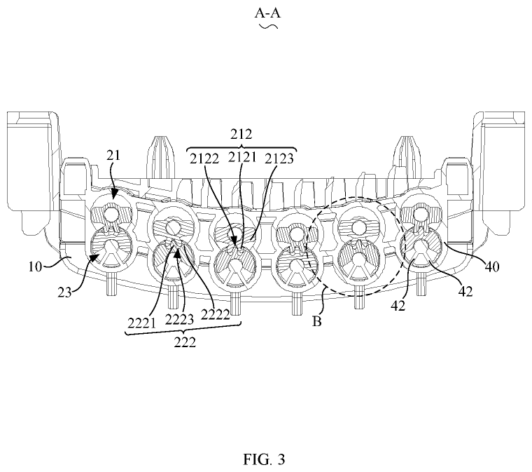

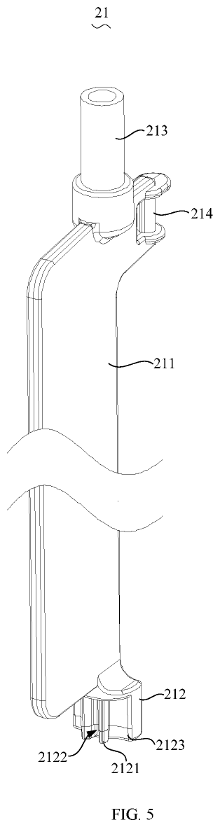

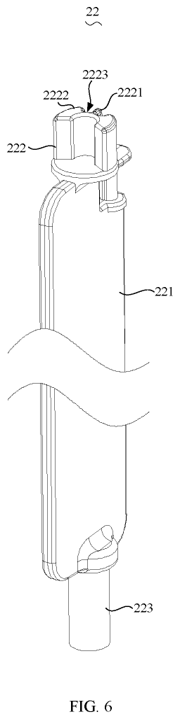

Referring to FIG. 3 to FIG. 6, in some embodiments, the first fan blade 21 includes a first blade 211 and a first meshing portion 212 provided at one end of the first blade 211. The second fan blade 22 includes a second blade 221 and a second meshing portion 222 provided at one end of the second blade 221. The second meshing portion 222 is meshed with the first meshing portion 212. The first meshing portion 212 and the second meshing portion 222 can be selected as two gears with the same parameters to achieve a transmission ratio of 1:1, enabling the first fan blade 21 and the second fan blade 22 to rotate synchronously, thereby ensuring that the amount of air delivered by the air outlet device 100 to the two sides that are farther apart (or the two areas that are farther apart) is approximately equal, which avoids the airflow turbulence caused by non-synchronized blades, and thus provides a more comfortable user experience.

Furthermore, the first meshing portion 212 and the second meshing portion 222 are respectively arranged at the ends of the first blade 211 and the second blade 221 that are close to each other. Compared with separately providing a complete set of transmission devices to transmit power to the first blade 211 and the second blade 221, the present disclosure connects the first meshing portion 212 and the second meshing portion 222 respectively to the first blade 211 and the second blade 221, achieving structure compactness. This design not only saves space, but also makes the overall appearance of the device simpler and aesthetically pleasing, facilitating the installation and use of the device.

In some embodiments, the first meshing portion 212 and the first blade 211 are an integral member. Its manufacturing process is relatively simple, eliminating the need to separately process and then assemble the first meshing portion 212 and the first blade 211, reducing the number of production processes and molds, thereby lowering production costs and production cycles. Furthermore, the integrated design eliminates structural weaknesses that may be introduced by connecting members (such as screws, pins), avoids fan blade operation failures caused by loose or failed connections, enables the fan blade to withstand greater mechanical stress during rapid oscillation and long-term use, reduces the risk of breakage or damage, and enhances the reliability and service life of the entire air outlet device 100.

Furthermore, by integrating the first meshing portion 212 with the first blade 211, it can be ensured that the movements of the first blade 211 and the second blade 221 are more precise and synchronized during power transmission. This precise transmission relationship is crucial for achieving the coordination and consistency of synchronous air supply in opposite directions, effectively avoiding problems of uneven air supply or unbalanced air force caused by transmission errors.

In some embodiments, the second meshing portion 222 and the second blade 221 are an integral member and can achieve effects similar to the embodiment in which the first meshing portion 212 and the first blade 211 are an integral member, which will not be repeated here.

It can be understood that the first meshing portion 212 and the first blade 211 may also be integral member, while the second meshing portion 222 and the second blade 221 are separate members and are connected by means of screwing, snap-fitting or the like. Similarly, the first meshing portion 212 and the first blade 211 may be separate members, while the second meshing portion 222 and the second blade 221 are an integral member. Alternatively, the first meshing portion 212 and the first blade 211, as well as the second meshing portion 222 and the second blade 221 are all separate members. The materials of the first meshing portion 212 and the first blade 211 and the materials of the second meshing portion 222 and the second blade 221 may be the same or different, which is not limited in the present disclosure.

In addition, a plurality of through holes may be provided at intervals on each of the first blade 211 and the second blade 221, which helps to optimize the distribution of airflow, makes the airflow more uniform, reducing local airflow turbulence and energy loss. The plurality of through holes can also reduce the obstruction of the first blade 211 and the second blade 221 to the airflow, allowing air to pass through the first blade 211 and the second blade 221 more smoothly, thereby enhancing the air supply effect. The number or shape of the plurality of through holes are not specifically limited in the present disclosure.

Specifically, referring to FIG. 2 to FIG. 6, the first meshing portion 212 includes at least two first meshing teeth 2121, which are spaced apart to form at least one first tooth space 2122. The second meshing portion 222 includes at least one second meshing tooth 2221. The at least one second meshing tooth 2221 extends into the first tooth space 2122, thereby ensuring stable meshing between the first fan blade 21 and the second fan blade 22 during rotation, and ensuring transmission accuracy while avoiding jamming. This reduces the risk of slippage or tooth separation, thereby enhancing the reliability and stability of the transmission.

The design of second meshing tooth 2221 extending into the first tooth space 2122 increases the contact area of the meshed portions, thereby enhancing the meshing strength. This helps to maintain stable power transmission under high load or continuous operation conditions, extending the service life of the fan blade assembly 20. Through this precise meshing design, the opposite rotations of the first fan blade 21 and the second fan blade 22 can result in more uniform air supply, enhancing the comfort experience of users.

In some embodiments, the first meshing portion 212 further includes two first limiting portions 2123, and the at least two first meshing teeth 2121 are located between the two first limiting portions 2123 in a circumferential rotation direction of the first fan blade 21. The second meshing portion 222 further includes two second limiting portions 2222, and the at least one second meshing tooth 2221 is located between the two second limiting portions 2222 in a circumferential rotation direction of the second fan blade 22. Both the second limiting portions 2222 are spaced apart from the at least one second meshing tooth 2221 to form second tooth spaces 2223, and the two first meshing teeth 2121 extend into the two second tooth spaces 2223, respectively.

Wherein, the two first limiting portions 2123 are configured to abut against the second limiting portions 2222 in a one-to-one correspondence to limit the relative rotation angle of the first fan blade 21 with respect to the second fan blade 22. One oscillation cycle is defined as the time it takes the first fan blade 21 to rotate from the maximum travel angle in the first direction D1 to the maximum travel angle in the second direction D2. During the rotation of the first fan blade 21 from the maximum travel angle in the first direction D1 to the maximum travel angle in the second direction D2, one of the first meshing teeth 2121 moves into a corresponding second tooth space 2223. The movement continues until the second meshing tooth 2221 fully enters the first tooth space 2122 and both first meshing teeth 2121 are received within the corresponding two second tooth spaces 2223. Thereafter, the first fan blade 21 rotates towards a position at the maximum travel angle in the second direction D2. One of the first meshing teeth 2121 gradually moves out of the corresponding second tooth space 2223 until one of the first limiting portions 2123 abuts against the corresponding second limiting portion 2222. At this time, the relative rotation angle of the first fan blade 21 with respect to the second fan blade 22 reaches a maximum angle.

During one oscillation cycle as mentioned above, the second meshing tooth 2221 remains received within the first tooth space 2122, thereby maintaining the meshing relationship of the first fan blade 21 relative to the second fan blade 22, and avoiding the separation of the first meshing portion 212 from the second meshing portion 222. If such separation occurred, the first fan blade 21 and the second fan blade 22 would fail to oscillate synchronously.

With this configuration, the relative rotation angle of the first fan blade 21 with respect to the second fan blade 22 can be precisely defined, thereby preventing the fan blades from exceeding a designed range during oscillation, and avoiding structural damage or functional failure caused by excessive rotation. Further, a larger relative rotation angle of the first fan blade 21 with respect to the second fan blade 22 can be achieved, which leads to a larger air supply angle and a larger air supply coverage area.

The first meshing teeth 2121 and the first limiting portions 2123 may be an integral member, and the second meshing tooth 2221 and the second limiting portions 2222 may also be an integral member. By inserting the second meshing tooth 2221 into the first tooth space 2122, and inserting the two first meshing teeth 2121 into the two second tooth spaces 2223 respectively, mistakes can be effectively prevented during the actual installation, which improves the installation and production efficiency.

In some embodiments, the air outlet device 100 further includes a mounting bracket 40 connected to the air outlet frame 10. The mounting bracket 40 is provided with a mounting groove 41, in which both the first meshing portion 212 and the second meshing portion 222 are rotatably disposed. The mounting groove 41 of the mounting bracket 40 can ensure that the first meshing portion 212 and the second meshing portion 222 maintain stably meshed throughout oscillation, thereby reducing the risk of slippage or teeth separation. This enhances the precision and efficiency of power transmission, enabling more accurate control of the air supply angle and range, and improving the uniformity and effectiveness of the air supply.

The mounting bracket 40 may be made of materials such as aluminium, iron, stainless steel, plastic. The mounting bracket 40 provides stable support for the fan blade assembly 20, and restricts the movement ranges of the first meshing portion 212 and the second meshing portion 222. This ensures that the first meshing portion 212 and the second meshing portion 222 maintain precisely aligned and stable during the oscillation of the fan blades, thereby preventing excessive oscillation or misalignment of the fan blade assembly 20 during rotation. This helps to reduce vibrations and noises caused by unstable structures, enhances the structural stability, and thereby improving the operational reliability of the entire device.

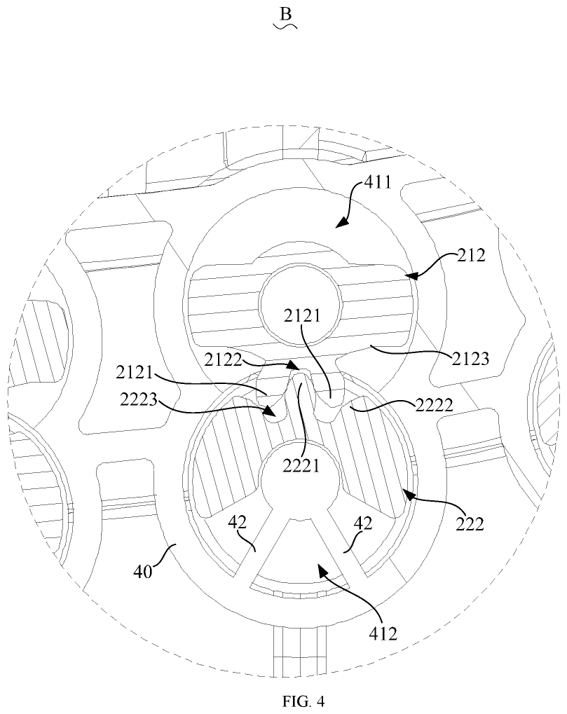

In some embodiments, as shown in FIG. 3 and FIG. 4, the mounting bracket 40 includes a third limiting portion 42 provided on the wall of the mounting groove 41. Wherein the third limiting portion 42 is configured to abut against any one of the second limiting portions 2222 to limit the relative rotation angle of the second fan blade 22 with respect to the mounting bracket 40. With this configuration, in addition to limiting the relative rotation angle of the first fan blade 21 with respect to the second fan blade 22 by means of the first limiting portions 2123 configured to abut against the corresponding second limiting portions 2222, the relative rotation angle of the second fan blade 22 with respect to the first fan blade 21 is precisely limited, ensuring that the second fan blade 22 oscillates within the designed range, and preventing structural damage caused by excessive rotation.

The arrangement of the third limiting portion 42 can effectively prevent the second fan blade 22 from rotating beyond a safe range, thereby reducing the safety risks caused by mechanical failure and enhancing the reliability of the air outlet device 100. Furthermore, by providing the third limiting portion 42 on the wall of the mounting groove 41, the mounting bracket 40 and the third limiting portion 42 are integrally formed, resulting in a compact and concealed structure. This helps to optimize the internal spatial layout of the air outlet device 100, making its appearance simple and aesthetically pleasing, and facilitating its installation and use in limited space.

In one embodiment of the present disclosure, the air outlet frame 10 has a rectangular structure. The first fan blade 21 and the second fan blade 22 can be arranged in the length direction of the air outlet frame 10. Therefore, when the air outlet frame 10 is placed vertically, the length direction of the air outlet frame 10 is a vertical direction. In this case, the first fan blade 21 and the second fan blade 22 are arranged in the vertical direction. When the air outlet frame 10 is placed horizontally, the length direction of the air outlet frame 10 is a left-right direction. In this case, the first fan blade 21 and the second fan blade 22 are arranged in the left-right direction. Thus, the air outlet device 100 can adapt to various usage scenarios, providing users with multiple usage experiences and meeting their diverse usage demands.

The mounting groove 41 includes a first sub-groove 411 and a second sub-groove 412. The first meshing portion 212 is rotatably limited in the first sub-groove 411. The second sub-groove 412 communicates with the first sub-groove 411. The second meshing portion 222 is rotatably limited in the second sub-groove 412. By dividing the mounting groove 41 into two sub-slots, the space can be utilized more effectively, making the design of the mounting bracket 40 more compact. At the same time, it provides sufficient rotation space for each meshing portion, avoiding mutual interference, and making the installation and maintenance more convenient. Since the first meshing portion 212 and the second meshing portion 222 are respectively located in different sub-slots, they can be more easily positioned and fixed during installation, and more easily disassembled and inspected during maintenance.

In a configuration where the first fan blade 21 and the second fan blade 22 are arranged in the vertical direction, the first meshing portion 212 and the second meshing portion 222 are meshed with each other in the left-right direction or the front-rear direction of the air outlet frame 10. Correspondingly, the first sub-groove 411 and the second sub-groove 412 are spaced apart in the left-right or front-rear direction of the air outlet frame 10. Specifically, during installation, since the first fan blade 21 is provided above the second fan blade 22, the first meshing portion 212 can be inserted into the first sub-groove 411 from above. The bottom wall of the first sub-groove 411 is configured to limit the first meshing portion 212 from below, preventing the first meshing portion 212 from being over-inserted and thereby disengaged from the mounting groove 41. If such disengagement occurs, precise meshing with the second meshing portion 222 would be adversely affected. Accordingly, for the second fan blade 22 positioned below the first fan blade 21, its second meshing portion 222 can be inserted into the second sub-groove 412 from below. The top wall of the second sub-groove 412 is similarly configured to limit the second meshing portion 222 from above, thereby preventing the second meshing portion 222 from being disengaged from the mounting groove 41. This ensures the meshing transmission effect, and thereby ensures the air supply effect.

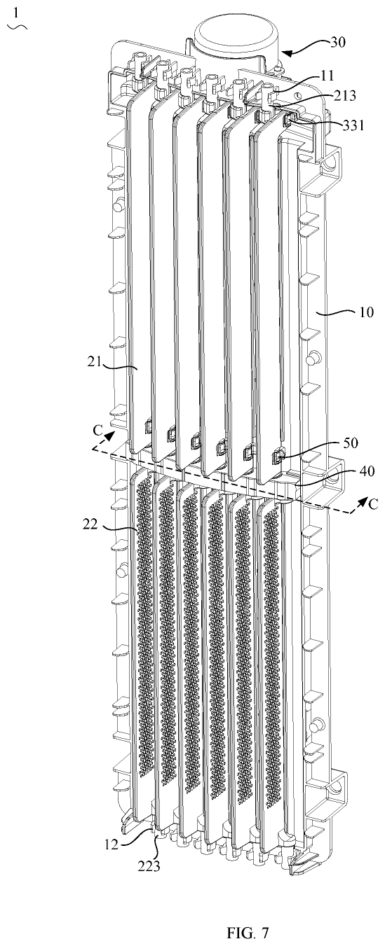

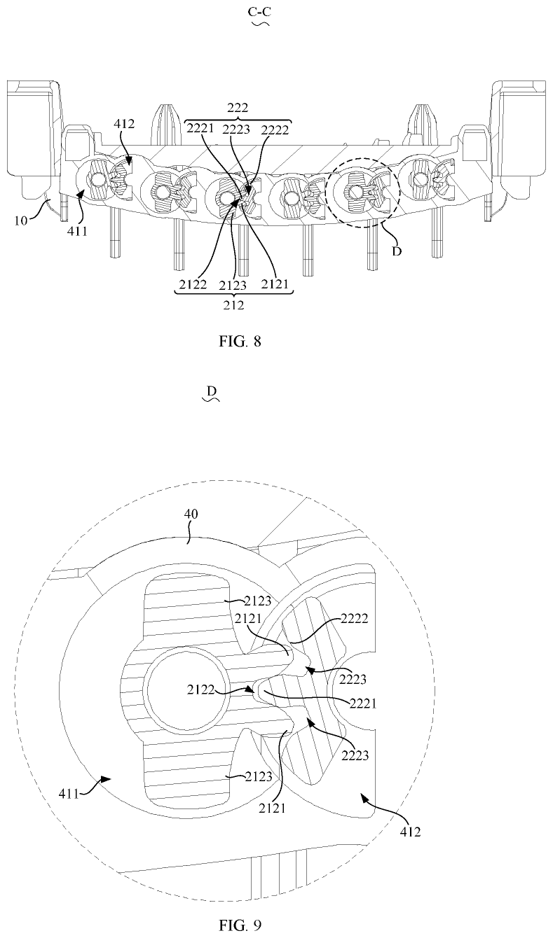

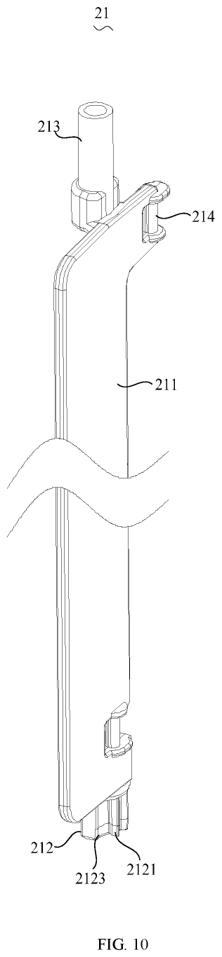

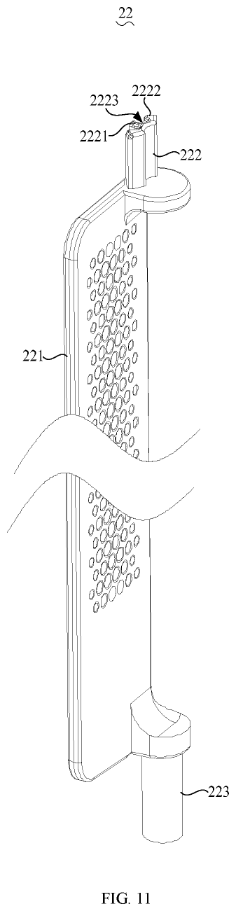

Furthermore, referring to FIG. 7 to FIG. 11, the first meshing portion 212 and the second meshing portion 222 are meshed with each other in the left-right direction of the air outlet frame 10. The first sub-groove 411 and the second sub-groove 412 are spaced apart from each other in the left-right direction of the air outlet frame 10. Since the first blade 211 and the second blade 221 are spaced apart from each other in the left-right direction, the overall structure has a higher utilization rate of space in the left-right direction and is more compact. Moreover, in the front side air outlet direction, the mounting bracket 40 does not protrude too much on the front side, thereby making the overall appearance more aesthetically pleasing and harmonious.

In some embodiments, a dimension of mutual meshing between the first meshing portion 212 and the second meshing portion 222 in the first direction D1 is no less than 4 mm. When the dimension of mutual meshing between the first meshing portion 212 and the second meshing portion 222 is less than 4 mm, the small meshing dimension can easily result in transmission backlash, while a sufficient meshing dimension can reduce vibration and noise caused by the transmission backlash, improving the operational smoothness and quietness of the device. When the dimension of mutual meshing between the first meshing portion 212 and the second meshing portion 222 is too large, it will make the structures of the first meshing portion 212 and the second meshing portion 222 too large, causing the mounting bracket 40 to be too large. This not only adversely affects the appearance but also blocks more air outflow, thereby reducing the air supply coverage area.

A reasonable meshing dimension helps optimize the spatial layout of the fan blade assembly 20 and the mounting bracket 40, making the entire air outlet device 100 more compact, saving installation space, and thereby enabling the air outlet device 100 to better adapt to limited spaces and improving space utilization. Therefore, the dimension of mutual meshing between the first meshing portion 212 and the second meshing portion 222 is not less than 4 mm, and may specifically be 4 mm, 5 mm, 6 mm or 6.5 mm, etc., which is not limited in the present disclosure.

In some embodiments, the first fan blade 21 is arranged coaxially with the second fan blade 22, or rotation axes of the first fan blade 21 and the second fan blade 22 are parallel to each other. In a case where there are a plurality of first blades 211 and a plurality of second blades 221 and they are arranged at intervals in the vertical direction, each first blade 211 and the corresponding second blade 221 in the vertical direction can be arranged coaxially, or of course, their rotation axes can be arranged parallel to each other. Alternatively, one first blade 211 and the corresponding second blade 221 in the vertical direction can be arranged coaxially, while another first blade 211 adjacent to or spaced from that first blade 211 has its rotation axis parallel to the rotation axis of the corresponding second blade 221. This configuration makes the air outlet device 100 more flexible, allows adaptive adjustment to the first fan blade 21 and the second fan blade 22 according to specific air supply demands to meet different air blowing needs of users.

In some embodiments, the air outlet device 100 further includes a connecting member 50 connecting all the first blades 211 so that all the first blades 211 rotate synchronously. Alternatively, the connecting member 50 connects all the second blades 221 so that all the second blades 221 rotate synchronously. Of course, two connecting member 50 may also be provided, connecting all the first blades 211 and all the second blades 221 respectively, so that all the first blades 211 and all the second blades 221 rotate synchronously. Connecting all the first blades 211 or the second blades 221 through the connecting members 50 allows all blades to move synchronously. This synchronous rotation design ensures coordination among the fan blades, improves the uniformity and efficiency of air supply. Furthermore, during installation, the spacing relationship between each first blade 211 or each second blade 221 is determined through the connecting member 50. Specifically, a plurality of claws can be provided on the connecting member 50, and a snap-fit pin can be provided at the same position on each first blade 211 or each second blade 221. By correspondingly snap-fitting each claw onto a corresponding snap-fit pin, synchronous rotation and equidistant installation are achieved, making the installation quick and convenient. Further, this arrangement ensures relatively high precision in synchronous rotation, thereby improving both installation efficiency and air supply efficiency.

Wherein at least one of the first blades 211 is meshed with at least one of the second blades 221, or the plurality of first blades 211 and the plurality of second blades 221 are meshed with each other in a one-to-one correspondence. This can ensure the accuracy and stability of power transmission, reduce energy loss, and improve power transmission efficiency. The synchronous rotation design and precise meshing relationship reduce the vibration and noise of the fan blades during their movement, improving the operational stability and reliability of the air outlet device 100. The connecting member 50 enables all the blades to adjust their angles synchronously, resulting in more uniform air supply. The airflow is distributed more uniformly on both sides, avoiding potential problems of uneven air supply.

In some embodiments, the fan blade assembly 20 further includes a third fan blade, which is meshed with the first fan blade 21, such that the first fan blade 21 drives the third fan blade to rotate in the second direction D2. Alternatively, the third fan blade is meshed with the second fan blade 22, such that the second fan blade 22 drives the third fan blade to rotate in the first direction D1. The third fan blade may also include a plurality of third blades which rotate synchronously through the connecting member 50. The introduction of the third fan blades can distribute the load of the transmission system, reduce the force on the two sets of the fan blades, and enhance the mechanical strength and service life of the entire system. The design of the multi-stage transmission and distributed loads can also reduce the vibration and noise caused by excessive force on the single fan blade, thereby improving the operational stability and reliability of the air outlet device 100.

In some other embodiments, the fan blade assembly 20 may further include a fourth fan blade which can be meshed with the first fan blade 21 or the third fan blade, such that the first fan blade 21 or the third fan blade drives the fourth fan blade to rotate in the second direction D2 or in the first direction D1. With this configuration, the fan blade assembly 20 has a bidirectional multi-fan-blade structural form, which can further accommodate more usage scenarios, meet various air supply demands, and further increase the air supply coverage area. When some of the fan blades are damaged, the remaining fan blades can still operate effectively to meet the requirement of synchronous air supply in opposite directions. Through multi-stage transmission and the coordinated movement of the plurality of fan blades, more uniform air supply can be achieved, enhancing the comfort experience of users. Further, the number of groups in the fan blade assembly 20 is not limited in the present disclosure.

In some embodiments, referring to FIG. 1 to FIG. 6 again, one of the air outlet frame 10 and an end of the first fan blade 21 away from the second fan blade 22 is provided with a first snap-fit member 213, and the other is provided with a first slot 11. The first snap-fit member 213 is in snap-fit engagement with the first slot 11, and is rotatable in the first slot 11. Alternatively, one of the air outlet frame 10 and an end of the second fan blade 22 away from the first fan blade 21 is provided with a second snap-fit member 223, and the other is provided with a second slot 12. The second snap-fit member 223 is in snap-fit engagement with the second slot 12, and is rotatable in the second slot 12. The first snap-fit member 213 is rotatably connected to the first fan blade 21, and the second snap-fit member 223 is rotatably connected to the second fan blade 22, such that after the first fan blade 21 and the second fan blade 22 are fixed to the air outlet frame 10, the first fan blade 21 and the second fan blade 22 can still oscillate relative to the air outlet frame 10. The engagement of the snap-fit member and the slot makes the installation process of the fan blade assembly 20 and the air outlet frame 10 simpler and faster. Installation can be completed simply by inserting the snap-fit member into the slot after aligning them, without the need for additional tools and complex assembly steps. This design reduces assembly time and labor costs, and is particularly suitable for mass production and rapid assembly scenarios, significantly saving production and installation costs.

The close engagement between the snap-fit member and the slot ensures a firm connection between the fan blade assembly 20 and the air outlet frame 10, preventing the fan blade assembly 20 from loosening or falling off during rotation, thereby enhancing the mechanical stability of the entire air outlet device 100. The design of the snap-fit member and the slot also makes the disassembly of the fan blades convenient and quick, facilitating cleaning and maintenance. Users or maintenance personnel can easily disassemble the fan blades for cleaning, and then reinstall them, thereby extending the service life of the device. Furthermore, the design of the snap-fit member and the slot makes the connection between the fan blade assembly 20 and the air outlet frame 10 more compact, saving installation space. This enables the entire air outlet device 100 to better adapt to the limited space, improving space utilization helping optimize the layout of the fan blade assembly 20 within the air outlet frame 10, and making the overall structure of the air outlet device 100 more reasonable and the appearance simpler.

In some embodiments, the drive assembly 30 includes a drive member 31, a drive wheel 32 and a transmission bracket 33. The drive member 31 may be a single-phase AC asynchronous motor or a DC brushless motor. The drive wheel 32 is eccentrically connected to an output shaft of the drive member 31, or is an eccentric wheel. After the motor is powered on, its stator winding generates a rotating magnetic field that exerts an electromagnetic force on the rotor, causing it to rotate. This converts electrical energy into mechanical energy, which drives the drive wheel 32 to rotate. The transmission bracket 33 has a middle portion rotatably connected to the air outlet frame 10. The transmission bracket 33 has one end drivingly connected to the drive wheel 32, and the other end fixedly connected to the first fan blade 21 or the second fan blade 22. Thus, the rotational motion of the drive wheel 32 is converted into an oscillating motion, and the first fan blade 21 or the second fan blade 22 is driven to oscillate for air supply. By adjusting the rotational speed of the drive member 31, the oscillation speed of the first fan blade 21 and the second fan blade 22 can be precisely controlled, thereby enabling flexible adjustment of the air speed. This design enables users to select an appropriate air speed based on their actual needs, meeting the air conditioning requirements in different scenarios.

Specifically, the drive assembly 30 is provided above the fan blade assembly 20. The drive member 31 can be connected to the top plate 10a of the air outlet frame 10 by means of screwing, snap-fitting, welding or the like, to stably install the drive member 31 on the top of the air outlet frame 10, thereby preventing the mechanical vibration generated by the drive member 31 during operation from adversely affecting the fan blade assembly 20. After the drive wheel 32 is connected to the drive shaft of the drive member 31, it can be located behind the air outlet frame 10. This avoids interference of the drive wheel 32 with the oscillation of the fan blade assembly 20 during rotation, which would otherwise adversely affect air outflow.

One end of the transmission bracket 33 is drivingly connected to the drive wheel 32. The transmission bracket can extend from the rear to the front and protrude from below the top plate 10a to the front side of the air outlet frame 10, thereby being fixedly connected to the first fan blade 21 or the second fan blade 22. The fixed connection method can be selected such that one of the transmission bracket 33 and the first fan blade 21 is provided with a third snap-fit member 214, and the other one of the transmission bracket 33 and the first fan blade 21 is provided with a third slot 331. The third snap-fit member 214 is in snap-fit engagement with and fixedly connected to the third slot 331, thus enabling effective transmission between the transmission bracket 33 and the first fan blade 21. This configuration ensures that the operation of the entire drive device does not obstruct the oscillation path of the fan blade assembly 20, thereby guaranteeing the air supply effect and increasing the air supply coverage area.

In some embodiments, the air outlet device 100 also includes a lower mounting cover 60, which is connected to the bottom of the air outlet frame 10, and together with the air outlet frame 10, encloses the fan blade assembly 20 within the air outlet frame 10. The connection between the lower mounting cover 60 and the air outlet frame 10 enhances the structural stability of the entire air outlet device 100, ensures that the fan blade assembly 20 will not shift or shake during operation, and improves the mechanical stability of the air outlet device 100. The lower mounting cover 60 can prevent foreign substances (such as dust and dirty water) from entering the interior of the air outlet frame 10 from the bottom, protecting the fan blade assembly 20 from damage, enhancing the safety of the air outlet device 100. Further, the lower mounting cover 60 provides additional protection for the fan blade assembly 20, thereby reducing the risk of damage to internal components due to external collision or vibration, and extending the service life. Furthermore, the lower mounting cover 60 is provided at the bottom, which not only makes the appearance of the air outlet device 100 simpler and aesthetically pleasing, but also hides the connection structure between the bottom of the air outlet frame 10 and the fan blade assembly 20, thereby enhancing the visual appeal of the product.

The same or similar reference signs in the drawings of this embodiment correspond to the same or similar components. In the description of the present disclosure, it should be understood that, the orientations or positional relationships indicated by the terms such as “upper”, “lower”, “left”, and “right” are based on the orientations or positional relationships shown in the drawings, and are only for convenience of describing the present disclosure and simplifying the description, rather than indicating or implying that the device or element referred to must have a specific orientation or be constructed and operated in a specific orientation. Therefore, the terms describing the positional relationships in the drawings are only for exemplary illustration, and cannot be construed as limiting the present disclosure. For a person skilled in the art, the specific meanings of the above terms can be understood according to specific situations.

The above descriptions are merely preferred embodiments of the present disclosure, and are not intended to limit the present disclosure. Any modifications, equivalent substitutions, improvements, and the like made within the spirit and principle of the present disclosure shall be included in the protection scope of the present disclosure.

1. An air outlet device, applied to an air conditioning apparatus and comprising:
an air outlet frame;
a fan blade assembly comprising at least a first fan blade and a second fan blade, wherein one end of the first fan blade is meshed with one end of the second fan blade, and both the first fan blade and the second fan blade are rotatably provided on the air outlet frame; and
a drive assembly, which is drivingly connected to the first fan blade to drive the first fan blade to rotate in a first direction, causing the first fan blade to drive the second fan blade to rotate in a second direction opposite to the first direction.

2. The air outlet device according to claim 1, wherein the first fan blade comprises a first blade and a first meshing portion provided at one end of the first blade; and, wherein
the second fan blade comprises a second blade and a second meshing portion provided at one end of the second blade, wherein the second meshing portion is meshed with the first meshing portion.

3. The air outlet device according to claim 2, wherein the first meshing portion comprises at least two first meshing teeth, which are spaced apart to form at least one first tooth space; and
the second meshing portion comprises at least one second meshing tooth extending into the first tooth space.

4. The air outlet device according to claim 3, wherein the first meshing portion further comprises two first limiting portions, and the at least two first meshing teeth are located between the two first limiting portions in a circumferential rotation direction of the first fan blade; and
the second meshing portion further comprises two second limiting portions, and the at least one second meshing tooth is located between the two second limiting portions in a circumferential rotation direction of the second fan blade, wherein both the second limiting portions are spaced apart from the at least one second meshing tooth to form second tooth spaces, and the two first meshing teeth extend into the two second tooth spaces respectively; and,
wherein the two first limiting portions are configured to abut against the second limiting portions in a one-to-one correspondence to limit a relative rotation angle of the first fan blade with respect to the second fan blade.

5. The air outlet device according to claim 4, wherein the first meshing portion and the first blade are an integral member, and the second meshing portion and the second blade are an integral member.

6. The air outlet device according to claim 4, further comprising:
a mounting bracket connected to the air outlet frame, wherein the mounting bracket is provided with a mounting groove, in which both the first meshing portion and the second meshing portion are rotatably disposed.

7. The air outlet device according to claim 6, wherein the mounting bracket comprises:
a third limiting portion provided on a wall of the mounting groove; and,
wherein the third limiting portion is configured to abut against any one of the second limiting portions to limit a relative rotation angle of the second fan blade with respect to the mounting bracket.

8. The air outlet device according to claim 6, wherein the mounting groove comprises:
a first sub-groove, wherein the first meshing portion is rotatably limited in the first sub-groove; and
a second sub-groove communicating with the first sub-groove, wherein the second meshing portion is rotatably limited in the second sub-groove.

9. The air outlet device according to claim 2, wherein the first fan blade and the second fan blade are arranged in a vertical direction, and the first meshing portion and the second meshing portion are meshed with each other in a left-right direction or a front-rear direction of the air outlet frame.

10. The air outlet device according to claim 2, wherein a dimension of mutual meshing between the first meshing portion and the second meshing portion in the first direction is no less than 4 mm.

11. The air outlet device according to claim 1, wherein the first fan blade and the second fan blade are arranged in a vertical direction, or the first fan blade and the second fan blade are arranged in a left-right direction.

12. The air outlet device according to claim 11, wherein the first fan blade is arranged coaxially with the second fan blade, or rotation axes of the first fan blade and the second fan blade are parallel to each other.

13. The air outlet device according to claim 2, comprising a plurality of first blades and a plurality of second blades, and further comprising:
a connecting member, connecting all the first blades so that all the first blades rotate synchronously, and/or, connecting all the second blades so that all the second blades rotate synchronously; and,
wherein at least one of the first blades is meshed with at least one of the second blades, or the plurality of first blades and the plurality of second blades are meshed with each other in a one-to-one correspondence.

14. The air outlet device according to claim 1, wherein the fan blade assembly further comprises:
a third fan blade, wherein the third fan blade is meshed with the first fan blade, such that the first fan blade drives the third fan blade to rotate in the second direction; or, the third fan blade is meshed with the second fan blade, such that the second fan blade drives the third fan blade to rotate in the first direction.

15. The air outlet device according to claim 1, wherein one of the air outlet frame and an end of the first fan blade away from the second fan blade is provided with a first snap-fit member and the other is provided with a first slot, the first snap-fit member is in snap-fit engagement with the first slot and is rotatably disposed in the first slot; and/or,
one of the air outlet frame and an end of the second fan blade away from the first fan blade is provided with a second snap-fit member and the other is provided with a second slot, the second snap-fit member is in snap-fit engagement with the second slot and is rotatably disposed in the second slot.

16. The air outlet device according to claim 1, wherein the drive assembly comprises:
a drive member;
a drive wheel, wherein the drive wheel is eccentrically connected to an output shaft of the drive member or is an eccentric wheel; and
a transmission bracket having a middle portion rotatably connected to the air outlet frame, wherein the transmission bracket has one end drivingly connected to the drive wheel, and another end fixedly connected to the first fan blade or the second fan blade.

17. The air outlet device according to claim 16, wherein the drive assembly is provided above the fan blade assembly, one of the transmission bracket and the first fan blade is provided with a third snap-fit member, the other of the transmission bracket and the first fan blade is provided with a third slot, wherein the third snap-fit member is in snap-fit engagement with and fixedly connected to the third slot.

18. An air conditioning apparatus, comprising:
a main body including a fan; and
the air outlet device according to claim 1, wherein the air outlet device is arranged on an air outlet side of the fan;
wherein the air conditioning apparatus comprises one of an electric fan, an indoor air conditioning unit, an air purifier, and an air humidifier.
